(19) United States
(12) Patent Application Publication
(10) Pub. No.: US 2024/0308816 A1
(43) Pub. Date: Sep. 19, 2024

(54) Electric crane capable of being adjustably moved and positioned

(71) Applicant: YIDE PAN, Taichung City (TW)

(72) Inventor: YIDE PAN, Taichung City (TW)

(21) Appl. No.: 18/120,442

(22) Filed: Mar. 13, 2023

(51) Int. Cl. B66C 13/23; B66C 19/00; H02G 3/08

(52) U.S. Cl. CPC B66C 13/23; B66C 19/00; H02G 3/08

(57) ABSTRACT

An electric crane contains: a body and an electrical box. The body includes a drive device, a roller, a lift assembly, and a hanging assembly. The electrical box is electrically connected with an operation lever configured to be manually controlled by a user, and the operation lever has multiple switches. The drive device is a permanent magnet servo motor and has an encoder. The electrical box includes a control unit electrically connected with the encoder to feed back a detected position of a rotator of the permanent magnet servo motor and to compare whether an operating instruction of the permanent magnet servo motor matches with a rotating speed of the permanent magnet servo motor. The operation lever has a rotary hand wheel. The operation lever has a pulse signal generator. The pulse signal generator is electrically connected with the electrical box.

### TECHNICAL FIELD

The present invention relates to lifting equipment, and more particularly to an electric crane which is capable of being adjustably moved and positioned based on using requirements.

### BACKGROUND

The application of industry-related hoisting equipment is extremely extensive, and the use of hoisting equipment is more general, such as hoisting equipment, cranes, conveying equipment, etc. The fixed cranes in the category of lifting machinery and equipment are classified into: overhead cranes, outrigger cranes, bridge cranes, unloaders, cable cranes, container cranes and monorail cranes. Among them, electric cranes are the most widely used, such as in factories, high-frequency and high-load steelmaking plants, high-lift lifting places, and special harsh working environments. Electric cranes are classified into a chain type (as shown in FIG. 6) and a cable type (as shown in FIG. 7), and they includes a body 1, a drive device 2 configured to supply a rotation power, a roller 3 driven by the drive device to roll, a lift element 4 rolled on the roller 3, and a hanging assembly 5 configured to moveably hang an object. The drive device 2 has an operation lever 6 connected with the drive device 2 and having at least one switch, such that the at least one switch of the operation lever 6 is pressed to control the handing assembly 5 to move and hang the object. However, the drive device 2 can only be set within a quick speed and a slow speed of 5 Hz to 50 Hz. In other words, the drive device 2 cannot be operated below 5 Hz, so the hanging assembly will vibrate when moving to hang the object, thus dropping the object on a ground to case using danger.

The present invention has arisen to mitigate and/or obviate the afore-described disadvantages.

### SUMMARY

The primary aspect of the present invention is to provide an electric crane which is capable of being adjustably moved and positioned based on using requirements.

To obtain above-mentioned aspect, an electric crane provided by the present invention: a body configured to be movably fixed at a desired position in a height, and an electrical box configured to accommodate an electrical wiring system. The body includes a drive device configured to supply a rotation power, and the body includes a roller driven by the drive device to rotate, a lift assembly actuated by the roller to roll, and a hanging assembly actuated by the lift assembly to hang an object. The electrical box is electrically connected with an operation lever configured to be manually controlled by a user, and the operation lever has a first switch configured to control the hanging assembly to move upward, a second switch configured to control the hanging assembly to move downward, a third switch configured to control the hanging assembly to move leftward, a fourth switch configured to control the hanging assembly to move rightward, a fifth switch configured to control the hanging assembly to move forward and upward, and a sixth switch configured to control the hanging assembly to move backward and downward. The drive device of the body is a permanent magnet servo motor, and the drive device has an encoder electrically connected on an end thereof opposite to the permanent magnet servo motor. The electrical box includes a control unit accommodated therein and operated in a frequency conversion manner, the control unit is electrically connected with the encoder to feed back a detected position of a rotator of the permanent magnet servo motor and to compare whether an operating instruction of the permanent magnet servo motor matches with a rotating speed of the permanent magnet servo motor. The operating instruction of the permanent magnet servo motor is a rotating speed. The operation lever has a rotary hand wheel rotatably disposed on a portion thereof and spaced from the first switch, the second switch, the third switch, the fourth switch, the fifth switch and the sixth switch. The operation lever has a pulse signal generator rotatably controlled by the rotary hand wheel to generate pulse signals, and frequencies of the pulse signals of the pulse signal generator are configured to adjust a filter circuit so that signals acquired from the filter circuits are identical to the pulse signals and to generate a positive-feedback amplification, thus obtaining sine wave which has a same frequency as the pulse signals. The pulse signal generator is electrically connected with the electrical box to input transformed pulse signals to the control unit, and the control unit generates the speed instruction to the permanent magnet servo motor. A rotating speed of the rotary hand wheel is proportional to a baud rate of the encoder. The faster the rotary hand wheel that drives the pulse wave signal generator rotates, the faster the control unit generates the speed instruction to the permanent magnet servo motor of the drive device.

### BRIEF DESCRIPTION OF THE DRAWINGS

FIG. 1 is a perspective view showing the assembly of an electric crane according to a preferred embodiment of the present invention.

FIG. 2 is a cross sectional view taken along the line A-A of FIG. 1.

FIG. 3 is a block diagram showing the operation of the electric crane according to the preferred embodiment of the present invention.

FIG. 4 is a side plan view showing the operation of the electric crane according to the preferred embodiment of the present invention.

FIG. 5 is another side plan view showing the operation of the electric crane according to the preferred embodiment of the present invention.

FIG. 6 is a perspective view of a conventional electric crane. FIG. 7 is a perspective view of another conventional electric crane.

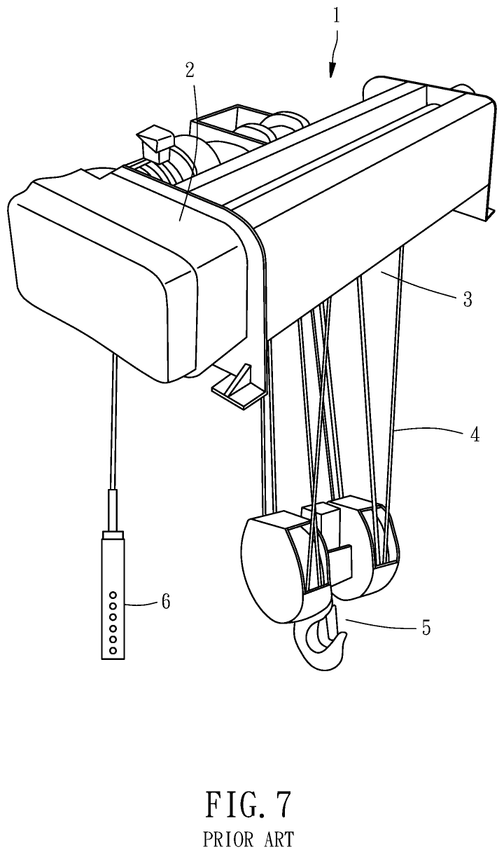

### DETAILED DESCRIPTION

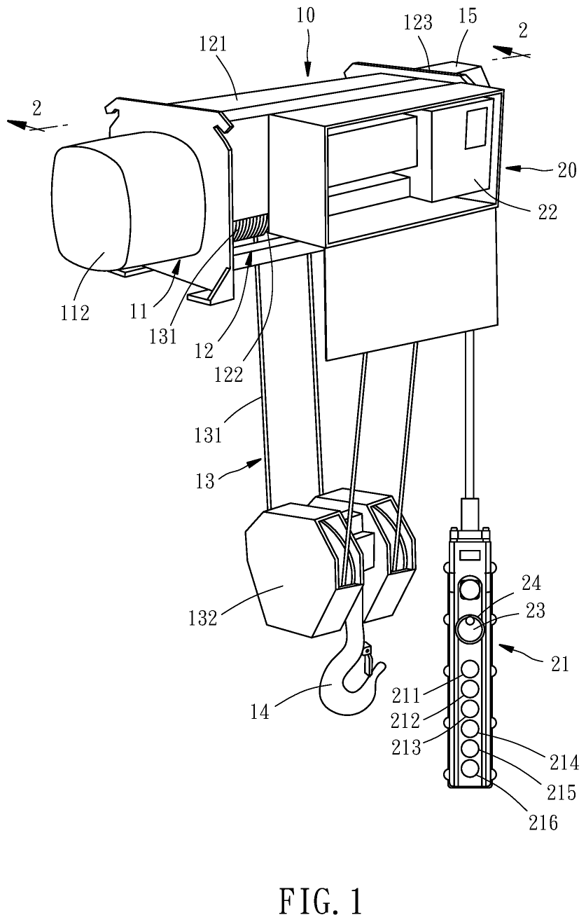

With reference to FIGS. 1-5, an electric crane capable of being adjustably moved and positioned according to a preferred embodiment of the present invention comprises: a body 10 configured to be movably fixed at a desired position in a height, and an electrical box 20 configured to accommodate an electrical wiring system. The body 10 includes a drive device 11 (such as a motor) configured to supply a power and a roller 12 driven by the drive device 11 to rotate, a lift assembly 13 actuated by the roller 12 to roll, and a hanging assembly 14 actuated by the lift assembly 13 to hang an object. The electrical box 20 is electrically connected with an operation lever 21 configured to be manually controlled by a user, and the operation lever 21 has a first switch 211 configured to control the hanging assembly 14 to move upward, a second switch 212 configured to control the hanging assembly 14 to move downward, a third switch 213 configured to control the hanging assembly 14 to move leftward, a fourth switch 214 configured to control the hanging assembly 14 to move rightward, a fifth switch 215 configured to control the hanging assembly 14 to move forward and upward, and a sixth switch 216 configured to control the hanging assembly 14 to move backward and downward, such that one of the first switch 211, the second switch 212, the third switch 213, the fourth switch 214, the fifth switch 215 and the sixth switch 216 is pressed to actuate the drive device 11, and the drive device 11 drives the hanging assembly 14 to move vertically and/or horizontally toward a desired position. The roller 12 includes a case 121, a rolling cylinder 122 axially connected with the drive device 11, a gear box 123 and a limit switch set 124 which are rotatably with the rolling cylinder 122 opposite to the drive device 11. The lift assembly 13 includes a cable 131 rolled on an outer wall of the rolling cylinder 122, and the lift assembly 13 includes a vertical moving holder 132 connected with the cable 131 opposite to the rolling cylinder 122.

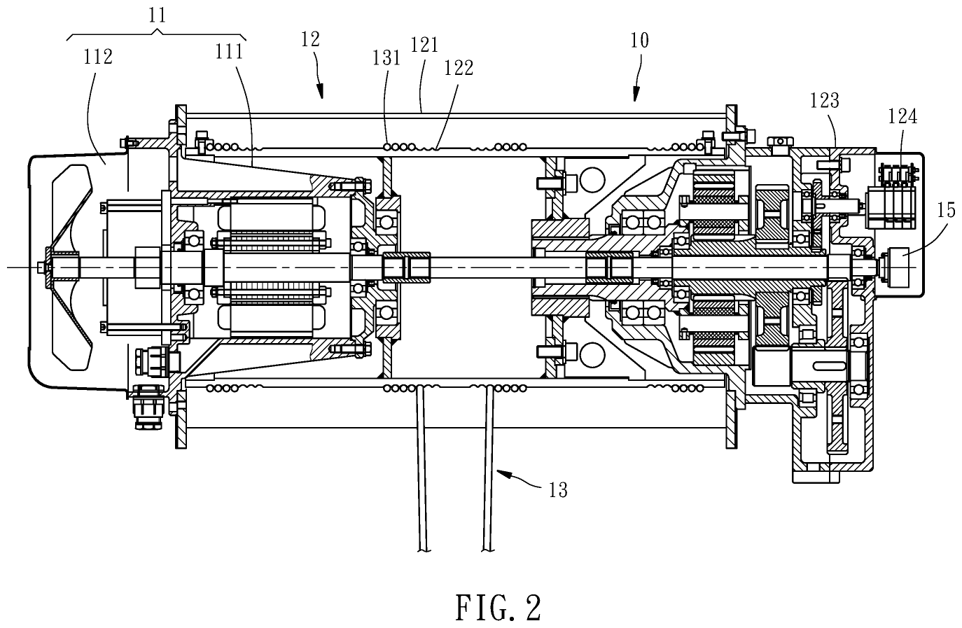

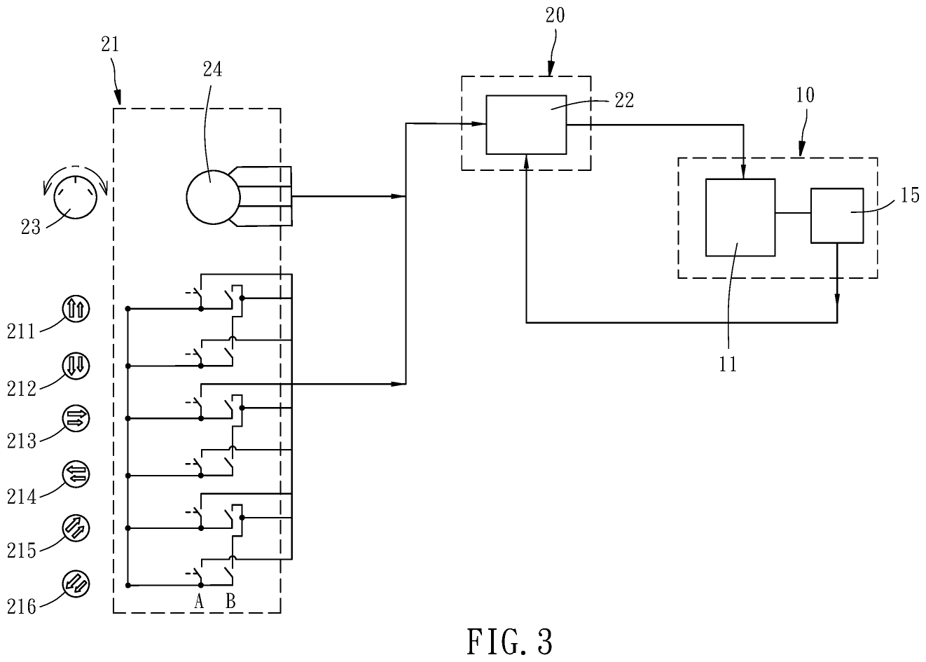

Referring to FIGS. 2 and 3, the drive device 11 of the body 10 is a permanent magnet servo motor 111, and the permanent magnet servo motor 111 is axially connected with a direct current (DC) brake 112, wherein the drive device 11 has an encoder 15 electrically connected on an end thereof opposite to the permanent magnet servo motor 111. The electrical box 20 includes a control unit 22 accommodated therein and operated in a frequency conversion manner. The control unit 22 is electrically connected with the encoder 15 to feed back a detected position of a rotator of the permanent magnet servo motor 111 and to compare whether an operating instruction (such as a speed instruction) of the permanent magnet servo motor 111 matches with an rotating speed of the permanent magnet servo motor 111.

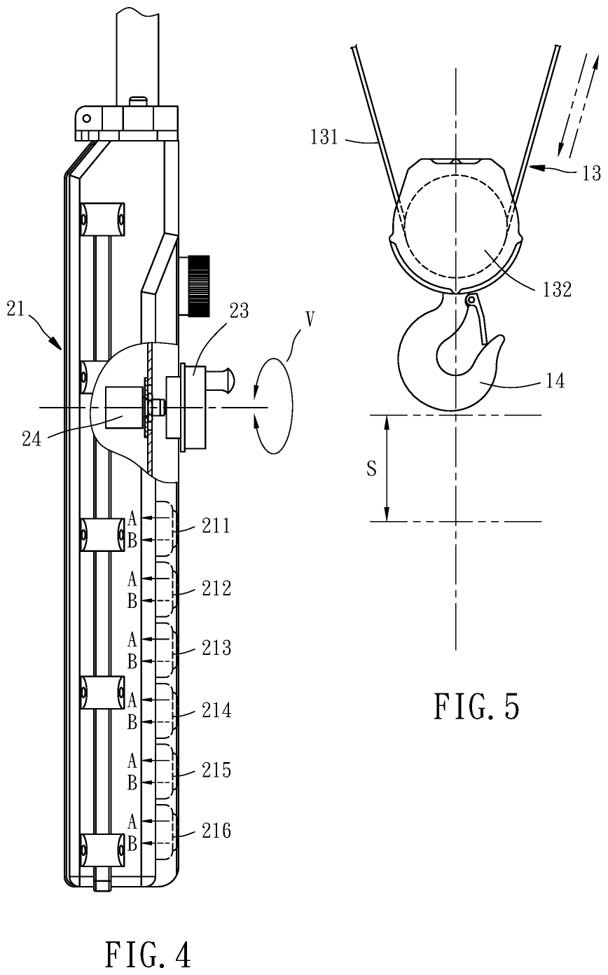

As shown in FIGS. 3-5, the first switch 211 to the sixth switch 216 of the operation lever 21 have two switching bosses A, B, wherein the two switching bosses A, B are electrically connected with the control unit 22 of the electrical box 20 so that the permanent magnet servo motor 111 is controlled to operate between a fixed quick speed and a fixed slow speed in a rated frequency below 5 HZ, after setting the fixed quick sped and the fixed slow speed by using the control unit 22. The operation lever 21 has a rotary hand wheel 23 rotatably disposed on a portion thereof and spaced from the first switch 211, the second switch 212, the third switch 213, the fourth switch 214, the fifth switch 215 and the sixth switch 216, wherein the operation lever 21 has a pulse signal generator 24 rotatably controlled by the rotary hand wheel 23 to generate pulse signals, and frequencies of the pulse signals of the pulse signal generator 24 are configured to adjust a filter circuit so that signals acquired from the filter circuits are identical to the pulse signals and to generate a positive-feedback amplification, thus obtaining sine wave which has a same frequency as the pulse signals. The pulse signal generator 24 is electrically connected with the electrical box 20 to input transformed pulse signals to the control unit 22, and the control unit 22 generates the speed instruction to the permanent magnet servo motor 111, wherein a rotating speed of the rotary hand wheel 23 is proportional to a baud rate of the encoder 15, for example, the faster the rotary hand wheel 23 that drives the pulse wave signal generator 24 rotates, the faster the control unit 22 generates the speed instruction to the permanent magnet servo motor 111 of the drive device 11. As shown in FIG. 4, the permanent magnet servo motor 111 operates within 0.1 Hz to 5 Hz, and the permanent magnet servo motor 111 adjustably drives the lift assembly 13 at a very slow speed within a vertical moving distance S of 1 mm to 2 mm after rotating the rotary hand wheel 23 at a rotating speed V.

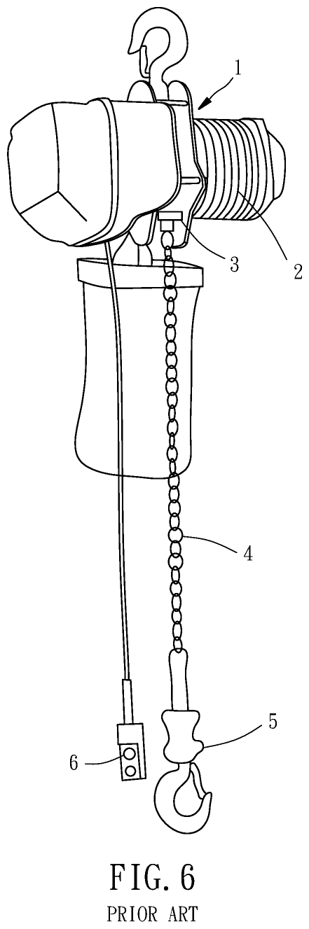

As illustrated in FIGS. 1 and 3, in operation, the user grasps the operation lever 21 and presses one of the first switch 211, the second switch 212, the third switch 213, the fourth switch 214, the fifth switch 215 and the sixth switch 216 to drive the body 10 to move. When the lift assembly 13 is driven to move vertically at the very slow speed, the rotary hand wheel 23 of the operation lever 21 is rotated clockwise or counterclockwise to drive the pulse signal generator 24 to send the pulse signals toward the control unit 22 of the electrical box 20, and the control unit 22 generates the speed instruction to the permanent magnet servo motor 111 so that the permanent magnet servo motor 111 operates within 0.1 Hz to 5 Hz, and the permanent magnet servo motor 111 adjustably drives the lift assembly 13 at the very slow speed within the vertical moving distance S of 1 mm to 2 mm after rotating the rotary hand wheel 23 at the rotating speed V, as shown in FIGS. 4 and 5, thus moving the electric crane at the desired speed based on the using requirements.

Thereby, the control unit 22 of the electrical box 20 is electrically connected with the encoder 15 to feed back the detected position of the rotator of the permanent magnet servo motor 111 and to compare whether the operating instruction of the permanent magnet servo motor 111 matches with the rotating speed of the permanent magnet servo motor 111, thus moving the electric crane at the desired speed based on the using requirements.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. An electric crane comprising: a body configured to be movably fixed at a desired position in a height, and an electrical box configured to accommodate an electrical wiring system;
the body including a drive device configured to supply a power, and the body including a roller driven by the drive device to rotate, a lift assembly actuated by the roller to roll, and a hanging assembly actuated by the lift assembly to hang an object;
the electrical box being electrically connected with an operation lever configured to be manually controlled by a user, and the operation lever having a first switch configured to control the hanging assembly to move upward, a second switch configured to control the hanging assembly to move downward, a third switch configured to control the hanging assembly to move leftward, a fourth switch configured to control the hanging assembly to move rightward, a fifth switch configured to control the hanging assembly to move forward and upward, and a sixth switch configured to control the hanging assembly to move backward and downward;
wherein the drive device of the body is a permanent magnet servo motor, and the drive device has an encoder electrically connected on an end thereof opposite to the permanent magnet servo motor;
wherein the electrical box includes a control unit accommodated therein and operated in a frequency conversion manner, the control unit is electrically connected with the encoder to feed back a detected position of a rotator of the permanent magnet servo motor and to compare whether an operating instruction of the permanent magnet servo motor matches with a rotating speed of the permanent magnet servo motor, wherein the operating instruction of the permanent magnet servo motor is a rotating speed;
wherein the operation lever has a rotary hand wheel rotatably disposed on a portion thereof and spaced from the first switch, the second switch, the third switch, the fourth switch, the fifth switch and the sixth switch, wherein the operation lever has a pulse signal generator rotatably controlled by the rotary hand wheel to generate pulse signals, and frequencies of the pulse signals of the pulse signal generator are configured to adjust a filter circuit so that signals acquired from the filter circuits are identical to the pulse signals and to generate a positive-feedback amplification, thus obtaining sine wave which has a same frequency as the pulse signals;
wherein the pulse signal generator is electrically connected with the electrical box to input transformed pulse signals to the control unit, and the control unit generates the speed instruction to the permanent magnet servo motor, wherein a rotating speed of the rotary hand wheel is proportional to a baud rate of the encoder;
wherein the faster the rotary hand wheel that drives the pulse wave signal generator rotates, the faster the control unit generates the speed instruction to the permanent magnet servo motor of the drive device.

2. The electric crane as claimed in claim 1, wherein the roller includes a rolling cylinder axially connected with the drive device, and the lift assembly includes a cable or a chain rolled on an outer wall of the rolling cylinder.

3. The electric crane as claimed in claim 1, wherein the first switch to the sixth switch of the operation lever have two switching bosses, wherein the two switching bosses are electrically connected with the control unit of the electrical box so that the permanent magnet servo motor is controlled to operate between a fixed quick speed and a fixed slow speed in a rated frequency below 5 HZ, after setting the fixed quick sped and the fixed slow speed by using the control unit.

4. The electric crane as claimed in claim 1, wherein the permanent magnet servo motor operates within 0.1 Hz to 5 Hz, and the permanent magnet servo motor adjustably drives the lift assembly at a very slow speed within a vertical moving distance of 1 mm to 2 mm after rotating the rotary hand wheel at a rotating speed.
